(19) United States
(12) Patent Application Publication
(10) Pub. No.: US 2018/0289021 A1
(43) Pub. Date: Oct. 11, 2018

(54) METHOD AND DEVICE FOR SHAPING BAGUETTES, LONG LOAVES AND ELONGATE ROLLS

(71) Applicant: KAAK GROEP B.V., Terborg (NL)

(72) Inventor: Bernard ZORN, Saverne (FR)

(73) Assignee: KAAK GROEP B.V.

(21) Appl. No.: 15/575,755

(22) PCT Filed: May 17, 2016
(86) PCT No.: PCT/FR2016/051160

§ 371 Date: Nov. 20, 2017

(30) Foreign Application Priority Data
May 18, 2015 (FR) 1554422

(51) Int. Cl. A21C 7/06

(52) U.S. Cl. CPC A21C 7/06

(57) ABSTRACT

Provided is a method and device for shaping dough to produce baguettes, long loaves, elongate rolls or the like. Starting with a laminated dough strip being spread out over a conveyor belt the laminated dough strip is cut in the longitudinal direction into a plurality of smaller strips, transversely spacing the smaller strips apart from each other, and cutting them to length by a transverse cut so as to define smaller dough strip portions extending longitudinally over the conveyor belt in transverse rows substantially perpendicular to the longitudinal axis of the conveyor belt. At least one transverse row of longitudinal smaller dough strip portions is shaped, driven by an alternating transverse movement of a shaping plate extending transversely to said conveyor belt and located above said row(s).

The present invention concerns production units for bakery, pastry and similar products and relates, particularly, to units for processing the dough after kneading for the manufacture of baguettes, long loaves, elongate rolls.

More particularly, the invention concerns a method and device for shaping the dough for the manufacture of bakery products.

At the current time there are essentially two shaping techniques for producing, after kneading, baguettes, long loaves, elongate rolls or the like. The first consists of supplying, on exiting the kneader and through a hopper, a dough dividing device which delivers balls of dough onto a suitable conveyor belt. These are, progressively, conveyed towards a device for shaping which consists of elongating these balls of dough transversely to the advancement of the conveyor belt, to form a sausage-like piece substantially matching the length of the baguette to produce, knowing that this sausage-like piece of dough can be further subdivided into two or more sections for the manufacture of long loaves, elongate rolls, etc.

The second solution consists of supplying with dough, on exiting the kneader, a laminating unit which, in its downstream part, delivers onto a suitable conveyor belt, a strip of dough of uniform thickness and width adapted to that of said conveyor belt.

This strip of dough is next cut up transversely by chopping into strands of regular width, which are then spaced apart from each other to once again undergo a shaping operation., essentially consisting in formatting, possibly after an operation of subdivision into two or more sections, according to the length of the baguette, the long loaf or the elongate rolls which it is desired to obtain.

In the context of the first solution, the operation of shaping the dough lumps consists of operations of elongation and formatting the dough to obtain, starting from a dough lump substantially in the shape of a ball, an elongate sausage-like piece. This working of the dough results in directly influencing its structure which will determine the characteristics of the bread crumb (dense or alveolar) after baking, but also that of the crust: thin or thick, hard, brittle or flexible.

For example, a ball of dough cut up and not shaped gives, after baking, a product that is firm, with a rather thick crust, and often with a very aerated crumb. By contrast, that same ball of dough when shaped, in addition to its cylindrical shape, will after baking give a loaf of which the crust is thin and of which the crumb is alveolar to a greater or lesser extent, according to the intensity of the shaping movements to which the dough lump is subjected.

In this connection, it should be recalled that it is usual, to promote the expansion of the loaf during baking, to make regular incisions in the surface of the dough by means of appropriate blades. These incisions or “blade slashes” have a distinct appearance on the surface of the baked bread, depending on whether the dough has been kneaded to a greater or lesser extent through the shaping operations. Thus, dough which has been little kneaded will give these blade slashes a rather effaced appearance after baking. Conversely, according to the intensity of the shaping movements to which a dough lump has been subjected to give it the elongate shape of a baguette, these blade slashes will appear very distinctly on the surface of the loaf after baking, with cut edges, referred to as “crests”, which are upright, specifically resulting from the dough taking on strength during the shaping.

Similarly, excessive shaping consisting of applying a strong and long mechanical action to the dough lump, gives the loaf a dense crumb and reduced volume after baking.

In conclusion, in the first solution referred to above, in which the shaping operation consists of transforming balls of dough into elongate sausage-like pieces for the manufacture of baguettes, long loaves or elongate rolls, necessarily leads to applying a substantial mechanical action of shaping to the dough.

On the contrary, in the context of the second solution, the strands of dough cut from a laminated strip of dough, may, from the outset, have the dimensions of the baguette or long loaf to manufacture. At most these strands may undergo operations of re-cutting to length for the manufacture of elongate rolls. However, the operations of cutting up the strip of dough into strands have the drawback of not closing off the dough on its cut sides and at the ends. However, it is known that to promote the peripheral development of a dough crust that is approximately uniform at the time of baking, it was necessary, at the location of these cut edges, for the surface layer of dough to close over the layer of dough below. As a matter of fact, on account of the mechanical actions they have necessarily undergone during the laminating operation of the strip, the upper layer of dough and the lower layer of dough below have acquired force which will lead to different baking relative to the cut sides of the strands of dough. Therefore, this second solution also requires shaping of these strands of dough. However, the mechanical action exerted on the dough in this case is much more reduced.

In each of these two solutions referred to above, the shaping is performed in the course of the movement of the conveyor belt on which the dough lumps to shape or the cut up strands of dough lie. The products are thus shaped successively one behind another. At most, a dough strand or a sausage-shaped piece of dough can be cut into two or more sections which are capable of being shaped simultaneously.

Furthermore, there is known from document EP 1 579 765 a method and a device for differently shaping pieces of dough delivered in transverse rows on a conveyor belt downstream of a unit for laminating and cutting up a strip of dough. More particularly, according to the method described in this prior document, it is also required to cut up a strip of dough in the longitudinal direction for the purpose of defining strands of dough which are made to be transversely spaced apart from each other. These strands are next cut up into pieces of dough extending in transverse rows on a conveyor belt.

Some of these pieces of dough of a transverse row do not undergo any shaping, others are subjected to an operation of shaping into a ball, while still others are shaped in roller-shaped pieces of dough which come to be laid transversely, that is to say perpendicularly relative to the axis of advancement of the conveyor belt.

The means implemented to shape these pieces of dough, depending on the case into balls or into roller shapes, are distinct. Since the shaping into balls cannot be carried out under the effect of the advancement of the conveyor belt on which lie the pieces of dough, the device for shaping into a ball is subjected to cyclical movement during which:

it is lowered over the conveyor belt and accompanies it during its advancement, while shaping the pieces of dough into balls;

next it is raised and moves in the opposite way to the direction of movement of the said belt, in order to regain its initial position for a new cycle.

Another solution is often implemented for cutting up and shaping of a laminated strip of dough for the purpose of manufacturing baguettes, long loaves or elongate rolls. Especially, the laminated strip of dough undergoes cutting-up into strands of dough which are caused to be spaced apart transversely to individualize them, the cutting up not being transverse, but longitudinal. These longitudinal strands are next cut up in length by transverse cutting up to define sections of strands of dough disposed in transverse rows of length adapted to the baguettes, long loaves or elongate rolls to manufacture. Next, these sections are successively taken charge of by a shaping device extending perpendicularly on one or the other of the lateral sides of said conveyor belt.

In summary, the sections of dough strand are taken charge of by a lateral shaping device while conveying them in a direction perpendicular to the conveyor belt on which they rested beforehand. This requires, in particular, these sections to be deposited from the initial conveyor belt onto that of the shaping device, which deposit, as will appear in more detail in the description below, is often tricky to carry out on account of the sticky nature of the dough. Moreover this deposit constitutes a real limit to the production speed.

Lastly, in each of the solutions set forth above, the production speed for this type of bakery product which baguettes, long loaves or elongate rolls are, depends on the capacity of the shaping devices to shape successively and one behind another the sections of dough strand cut up in advance. At most, according to the width of the conveyor belt such a shaping device is able simultaneously to process several small sections transversely aligned on that conveyor belt for the manufacture of elongate rolls. In all cases, the width of this conveyor belt is usually such that it is possible to process only a single section, or at most two sections of dough strand disposed in transverse alignment for the manufacture of baguettes.

As already mentioned succinctly above, this disposition, after shaping, of the sections of dough strand transversely relative to the direction of advancement of the conveyor belt on which they lie, poses the problem of their transfer, downstream of that conveyor belt, onto another conveyor belt or onto alveolar plates, according to the case, for their conveyance, for example, through a fermentation unit.

As a matter of fact, on arriving on the return roller downstream of that conveyor belt, these sections of dough strand only rarely have a strictly rectilinear disposition transversely on the latter. When, for the manufacture of elongate rolls, several dough sections transversely aligned on the conveyor belt have been simultaneously shaped upstream, they are often disposed offset on arriving on that return roller downstream. It is therefore necessary in order to provide, at each transfer, the realignment of these offset dough sections and/or in order to ensure a substantially rectilinear disposition of these dough sections on the conveyor plate or belt downstream, for the latter to comply with a sufficient stoppage time, of the order of at least one second.

This constraint constitutes a bottleneck and drastically limits production speeds. Thus, a production unit for baguettes implementing a shaping method according to the solutions of the state of the art, is scarcely capable of exceeding a production speed of the order of 3000-3600 baguettes per hour.

The present invention aims to address all the drawbacks of the solutions presented above through a shaping method and device capable of very quickly and simply shaping an entire transverse row, of sections of strands of dough extending longitudinally on the conveyor belt. Above all, this shaping can be carried out without acting on the dough more than necessary.

Essentially, the method and the device according to the invention avoid the shaping of the sections of dough strand one after another. Furthermore, this method and this device make it possible, downstream, after shaping of these sections of dough strand, to deposit them in alignment with the longitudinal direction in which they extend. There is thus no waiting time that must be complied with regard to the conveyor plate or belt downstream on which these shaped dough sections are to be deposited. Quite to the contrary, this conveyor plate or belt receiving these shaped dough sections must advance at an identical speed of advancement to that of the conveyor belt upstream on which the shaping operation takes place.

While being capable of overcoming what constituted a bottleneck and thus a limitation of the production speed, but also being capable of simultaneously shaping a high number of sections of dough strand disposed longitudinally in transverse rows on the conveyor belt, the solution according to the invention makes it possible, on a same production line and with a single shaper, to attain speeds which may be 4 to 5 times greater than the current production speeds.

To that end, the invention concerns a method of shaping dough for the manufacture of baguettes, long loaves, elongate rolls or the like, starting from a laminated strip of dough extending on a conveyor belt consisting:

of cutting up this laminated strip of dough in the longitudinal direction into several strands;

of transversely spacing apart these strands from each other;

of cutting the strands to length through a transverse cut for the definition of sections of strands of dough extending longitudinally on said conveyor belt, in transverse rows, substantially perpendicular to the longitudinal axis of this conveyor belt.

which method is characterized in that:

the shaping of at least one transverse row of sections of strands of longitudinal dough is carried out, under the action of a transverse rectilinear alternating movement of a shaping plate extending perpendicularly to said conveyor belt, above the transverse row or rows of sections of strands of dough to shape.

Advantageously, the method consists of:

conveying the transverse row or rows of sections of strands of dough to shape under said shaping plate held above the conveyor belt at a distance greater than the thickness of said sections of strands of dough;

lowering the shaping plate over said row or rows;

subjecting the shaping plate to alternating movement in a direction perpendicular to the conveyor belt on which lie said row or rows;

immobilizing and of raising said shaping plate beyond a shaping duration and/or a determined number of alternating translation cycles;

removing the row or rows of shaped sections of strands of dough.

The invention furthermore concerns a shaping device enabling the implementation of this method comprising a conveyor belt having longitudinal movement on which can lie transverse rows of sections of strands of dough extending longitudinally, characterized in that it comprises:

a shaping plate extending perpendicularly above said conveyor belt;

raising and lowering actuation means of the shaping plate;

and drive means to subject said shaping plate to an alternating rectilinear translation movement transversely above said conveyor belt.

The advantages resulting from the present invention are, undeniably, an improvement in the quality of the products obtained through fully controllable shaping, but also a substantial improvement in production speed in comparison with the solutions known previously.

The present invention will be better understood on the reading of the description which will follow referring to the appended drawings in which:

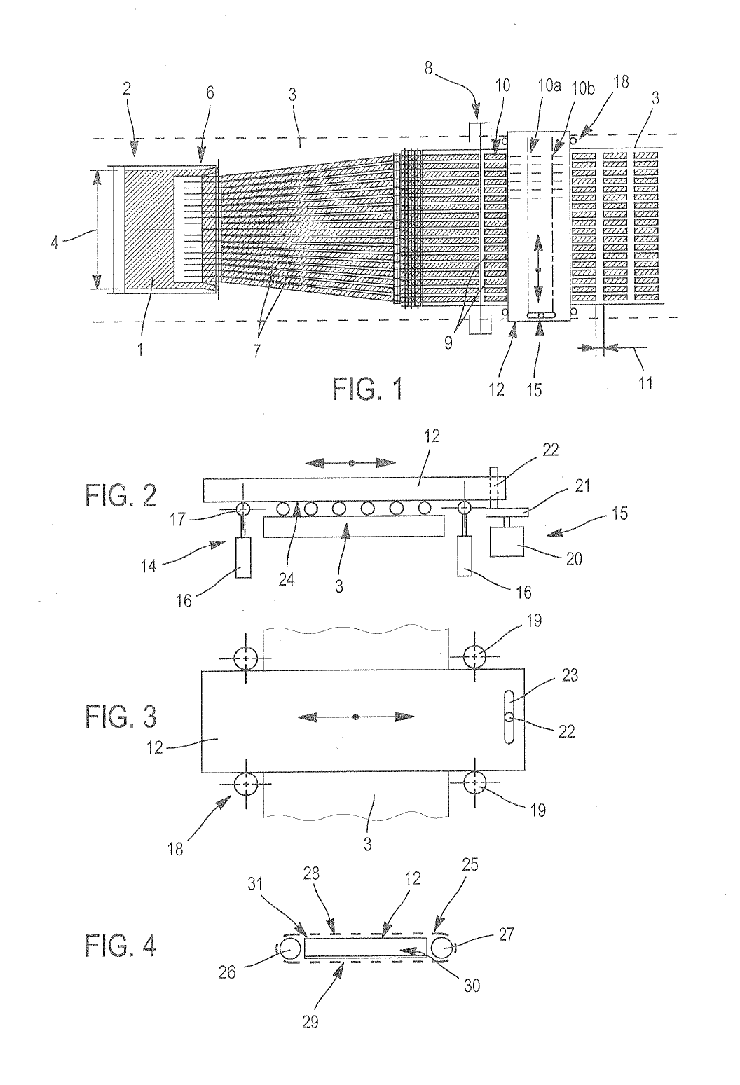

FIG. 1 is a partial diagrammatic illustration viewed from above of a production unit for bakery products such as baguettes, long loaves and/or elongate rolls, implementing a shaping device according to the invention;

FIG. 2 is a diagrammatic representation in elevation of this shaping device;

FIG. 3 is a diagrammatic view from above of FIG. 2;

FIG. 4 is a diagrammatic view in cross-section of an example embodiment of a shaping plate;

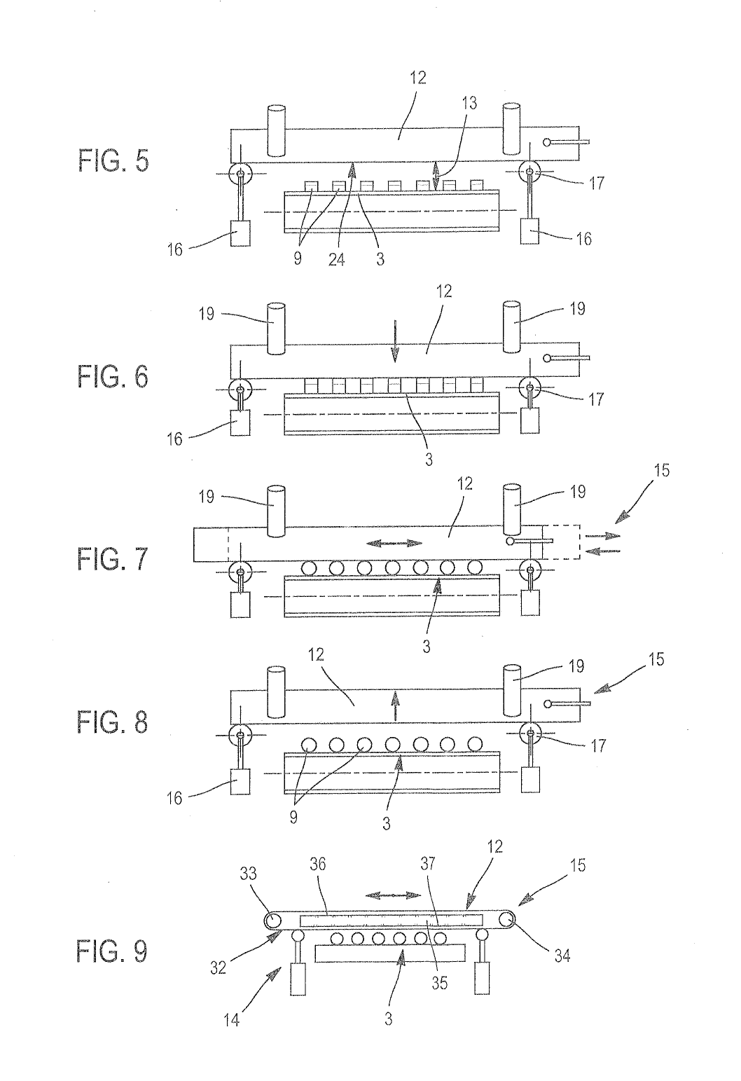

FIGS. 5, 6, 7 and 8 diagrammatically illustrate the various operations of a cycle for shaping two transverse rows of dough sections;

FIG. 9 illustrates diagrammatically in elevation another embodiment of the shaping plate.

As represented in the Figures of the appended drawing, the present invention concerns the operation of shaping in a production cycle of bakery products, of baguette, long loaf, elongate roll or the like.

Thus, as more particularly visible in FIG. 1, it is frequent to produce baguettes, long loaves, elongate rolls, starting with a laminated strip of dough 1 which is delivered by a laminating unit 2 disposed upstream on a conveyor belt 3 moving longitudinally.

Regarding this conveyor belt 3, it should be noted that it can take the form of several sections of conveyor belts disposed one behind another, some of which advance continuously and others of which advance discontinuously, this being according to the steps of the shaping method according to the invention. Thus, designation of the conveyor belt 3 may be understood to mean, depending on the case, the belt in its entirety or a section of the latter.

It is to be noted that after lamination 2, the laminated strip of dough 1 has a certain width 4, but also a thickness more particularly determined relative to the products it is desired to conceive downstream.

Through a unit for longitudinal cutting-up 6 this laminated strip of dough 1 is cut up into longitudinal strands 7 which, by suitable means, known by the person skilled in the art, are progressively spaced apart transversely from each other on the conveyor belt 3.

Next, a unit for transverse cutting-up 8 cuts up, by chopping, these strands 7 into sections 9 of which the length depends on the type of products, baguettes, long loaves, elongate rolls which it is wished to manufacture.

Downstream of the unit for transverse cutting-up 8 extend, perpendicularly on the conveyor belt 8, rows 10, 10a, 10b of sections 9 of strands of dough. These rows 10, 10a, 10b, referred to as transverse rows below in the description to improve the understanding thereof, are themselves spaced apart from each other by a determined distance 11.

This spacing is for example obtained through discontinuous advancement of the section of conveyor belt 3 on which are disposed the rows 10, 10a, 10b of sections 9 of strands of dough for them to be shaped, this being in comparison with the section of the conveyor belt in continuous operation upstream on which take place the operations of lamination and cutting up.

According to the method in accordance with the invention, the shaping is carried out simultaneously for all the dough sections 9 of at least one row 10, 10a, 10b under the action of an alternating translation movement of a shaping plate 12 extending perpendicularly relative to the conveyor belt 3, above this row or these rows 10, 10a, 10b of dough sections 9.

It is to be noted moreover that this shaping plate extends, preferably, strictly perpendicularly relative to the conveyor belt 3.

In summary and as can be seen in FIGS. 1 to 8, downstream of the unit for transverse cutting up 8, the transverse rows 10, 10a, 10b of dough sections 9 are conveyed, either individually, or two, three or more at a time, under said shaping plate 12. This extends, at that time, at a distance 13 greater than the thickness of the dough sections 9, substantially perpendicularly above the conveyor belt 3 (see FIG. 5).

During the following cycle, corresponding to FIG. 6, the shaping plate 12 is lowered, by virtue of appropriate raising and lowering actuation means 14, to come to press on that row or these rows 10a, 10b of dough sections 9.

By drive means 15, said shaping plate 12 is next subjected to an alternating rectilinear translation movement transversely above the conveyor belt 3 to shape said dough sections 9 (see FIGS. 6 and 7). In summary, this plate 12 moves with an alternating movement exclusively perpendicularly to the direction of movement of the conveyor belt 3, which also corresponds to the longitudinal direction of conveyance of the dough sections 9.

It is to be noted that given that, during this shaping operation, these sections 9 of dough are caused to roll transversely on the conveyor belt 3, the latter is defined with a greater width than that of a row 10, 10a, 10b, this being by a length corresponding to that amplitude of transverse movement imparted to said dough sections 9.

After shaping which can correspond to a duration or to a number of cycles of alternating movement imparted to the shaping plate 12, this is raised, as illustrated in FIG. 8, by said means 14 and a new shaping cycle can begin again after removal of the row or rows 10a, 10b of dough sections 9 shaped from below said shaping plate 12 and the conveyance under the latter of the following row or rows.

Therefore, the intensity of the shaping applied to the dough sections 9 essentially depends on the number of alternating translation cycles imparted to the shaping plate 12 and on the pressure exerted by the latter on these dough sections 9.

Although mention may have already been made, above, of the management, either by time measurement, or by counting the cycles of the alternating movements imparted to the shaping plate 12, the measurement of the pressure exerted by this latter on the dough sections 9 may be carried out by pressure detection means, such as are known by the person skilled in the art, or by determining the distance between the shaping plate 12 and the conveyor belt 3.

According to an advantageous embodiment, the raising and lowering actuation means 14 are constituted by jacks 16 on which the shaping plate 12 comes to rest via rollers 17, promoting the transverse movement of this shaping plate 12.

On a complementary basis, guide means 18, preferably but not necessarily, in the form of drums or rollers 19 ensure the guiding, in this direction perpendicular relative to the conveyor belt 3 of the shaping plate 12 above this belt.

FIG. 2 diagrammatically illustrates an example embodiment of the drive means 15.

Thus, these latter can take the form of a drive motor 20 causing to rotate, by means of a plate or connecting drive rod 21, an eccentric rod 22 engaged with the shaping plate 12. More particularly, this latter may be provided with a longitudinal slot 23, that is to say extending parallel to the direction of movement of the conveyor belt 3, albeit transversely fitting the cross-section of the eccentric rod 22. Thus, under the effect of the rotation of the latter, this rod moves with alternating movement, in the longitudinal slot 23, while alternatingly moving the shaping plate 12 in the transverse direction, that is to say in a direction exclusively perpendicular to the direction of movement of the conveyor belt 3.

The advantage of such drive means 15 of simplified design is longevity. The same applies as regards the raising and lowering actuation means 14 of the shaping plate 12 or as regards the means 18 contributing to its transverse guiding above the conveyor belt 3.

Although the shaping plate 12 may have a non-stick treatment, on its face 24 in contact with the dough sections 9, a second embodiment is provided below capable of advantageously addressing the problem of the sticking of the dough to that shaping plate 12.

This solution is illustrated in FIG. 4. In this case, a fabric band 25 envelops this shaping plate 12. More particularly, this fabric band 25 is wound longitudinally around the latter, passing over the return rollers 26, 27 extending along the transverse zones of that shaping plate 12. This makes it possible to make the dry upper branch 28 of the fabric band 25 pass alternately underneath and vice-versa, enabling the lower branch 29, moistened in contact with the dough, to dry and so forth.

Cleverly, the drive for this fabric band 25 to make the upper branch 28 and the lower branch 29 alternate can be carried out through the conveyor belt 3.

More particularly, this consists:

through the conveyor belt 3, more particularly through the management of its advancement downstream of the unit for transverse cutting-up 8, of maintaining a distance, between two transverse successive rows 10 of sections 9 of dough, which corresponds to at least twice the width of the shaping plate 12, i.e. two shaping cycles;

of bringing this free space under said shaping plate 12;

then of lowering the shaping plate 12 until it is brought into contact with the conveyor belt 3;

of causing this conveyor belt 3 to advance while driving the fabric band 25 to make the upper branch 28 of the latter pass under said shaping plate 12, while bringing the lower branch 29 above it;

of again raising the shaping plate 12 in preparation for the following shaping cycle.

The advantages arising from such a design reside in the simplification of the shaping device given that no separate motor means is required to drive the fabric band 25.

According to still another advantageous embodiment of the present invention, the shaping plate 12 may take the form of a box of which the peripheral walls delimit an internal volume 30 into which air, in particular hot air, may be blown. This may be distributed through openings or perforations in the lower face 24 and/or the upper face 31 of said shaping plate 12.

Thus, hot air distributed, for example, through a perforated piece of sheet metal constituting the lower face 24 of the shaping plate 12 makes it possible to avoid the phenomena of clogging and of sticking of the dough onto that lower face 24, or even onto the lower branch 29 of the fabric band 25 in contact with the dough sections 9.

In particular, air, in particular heated, passing through the lower face 24, or even through the upper face of the shaping plate 12, configured in box foam, promotes the drying of the fabric band 25.

By virtue of this particularity of the present invention, it is possible to work with moister dough in comparison with the units for manufacture of bakery products, of baguette, long loaf and elongate roll type implementing shaping devices in accordance with the state of the art.

It is to be noted that the lower face 24 of the shaping plate may be planar or structured in accordance with the result to obtain after shaping. In particular, this lower face 24 can comprise one or more longitudinal grooves, that is to say extending transversely relative to the conveyor belt 3 and thus, relative to the sections of dough strand 9. The benefit of this groove or these grooves consists of closing, at the time of shaping, the ends of the dough lumps which these sections 9 of dough strand define after shaping for the manufacture of baguettes, long loaves or elongate rolls. In particular, the number of these grooves preferably corresponds to the number of rows of these sections 9 of dough strand which are shaped simultaneously in a cycle performed by the shaping plate 12.

FIG. 9 illustrates still another embodiment of the invention in which the shaping plate 12 is substantially constituted by a mat 32 extending transversely on the conveyor belt 3 and to which can be transmitted an alternating movement during shaping. More particularly, this mat may describe a closed loop by partially winding around the return rollers 33, 34 at the ends of this shaping plate. As drive means 15, at least one of these return rollers 33, 34 can be motor-driven for an alternating drive in one direction then in the opposite direction.

Just as for the other embodiments described above, such a shaping plate, so designed, is subject to the raising and lowering actuation means 14, which, according to the shaping cycle such as illustrated in FIGS. 5 to 8, enables it to be moved vertically.

In this embodiment the same advantages are to be found as in that corresponding to FIG. 4. As a matter of fact, since the amplitude of the alternating movement communicated to the mat 32 is generally much less than the length of the shaping plate 12, between two shaping cycles and this time, through the drive means 15, the lower branch of this mat 32 moistened by the dough can be alternated with the upper branch. Similarly, it is possible for air to be blown between these lower and upper branches of the mat 32, which is preferably heated, to promote that drying and/or to avoid the clogging of the mat by the dough. Moreover, here too a box 35 with perforated upper 36 and/or lower 37 walls may be inserted between the return rollers 33, 34 to promote that distribution of air, in particular heated air, under the mat 32.

Furthermore, as previously, the lower face of such a box 35 may be structured, which structure is in the form of one or more grooves to format as may be desired the sections of dough strand 9 for example by closing their ends during shaping.

The present invention constitutes essential progress in these units for manufacture of bakery products of baguette, long loaf, elongate roll, etc., type.

1-13. (canceled)

14. A method of shaping dough for the manufacture of baguettes, long loaves, elongate rolls or the like, starting from a laminated strip of dough extending on a conveyor belt, consisting:
of cutting up this laminated strip of dough in the longitudinal direction into several strands;
of transversely spacing apart these strands from each other;
of cutting the strands to length through a transverse cut for the definition of sections of strands of dough extending longitudinally on said conveyor belt, in transverse rows, substantially perpendicular to the longitudinal axis of this conveyor belt; characterized by the fact that:
the shaping of at least one transverse row of sections of strands of longitudinal dough is carried out, under the action of a transverse rectilinear alternating movement of a shaping plate extending perpendicularly to said conveyor belt, above the row or rows of sections of strands of dough to shape.

15. The method according to claim 14, wherein:
the transverse row or rows of sections of strands of dough to shape are conveyed under said shaping plate held perpendicularly above the conveyor belt at a distance greater than the thickness of said sections of strands of dough;
the shaping plate is lowered over said row or rows;
the shaping plate is subjected to alternating movement in a direction exclusively perpendicular to the conveyor belt on which lie said row or rows;
said shaping plate is immobilized and raised beyond a shaping duration and/or a determined number of alternating translation cycles;
the row or rows of shaped sections of strands of dough are removed.

16. A shaping device for the implementation of the method according to claim 14, comprising a conveyor belt having longitudinal movement on which can lie transverse rows of sections of strands of dough extending longitudinally, characterized in that it comprises:
a shaping plate extending perpendicularly above said conveyor belt;
a raising and lowering actuator for the shaping plate;
and a driver for subjecting said shaping plate to an alternating translation movement transversely above said conveyor belt.

17. The shaping device according to claim 16, wherein the conveyor belt is defined in width greater than that of a transverse row of sections of strands of dough, this being by a length corresponding to the amplitude of transverse movement imparted to said sections of strands of dough by the alternating movement of the shaping plate exclusively perpendicularly to the conveyor belt.

18. The shaping device according to claim 16, wherein the raising and lowering actuator are constituted by cylinders on which the shaping plate comes to rest via rollers.

19. The shaping device according to claim 16, wherein it comprises a guide for providing transverse guiding of the shaping plate, perpendicularly above the conveyor belt.

20. The shaping device according to claim 16, wherein the driver comprises a drive motor causing to rotate, via a plate or connecting drive rod, an eccentric rod engaged in a longitudinal slot formed in the shaping plate for, under the effect of the rotation of the eccentric rod, alternatingly moving said shaping plate in the transverse direction.

21. The shaping device according to claim 16, wherein the shaping plate takes the form of a box of which the peripheral walls delimit an internal volume and comprising a lower face and/or an upper face provided with openings or perforations for distribution of air blown into said box.

22. The shaping device according to claim 16, wherein the shaping plate is enveloped with a fabric band.

23. The shaping device according to claim 22, wherein the fabric band is wound longitudinally around the shaping plate, passing over return rollers extending along the transverse zones of that shaping plate.

24. The shaping device according to claim 16, wherein the shaping plate is substantially constituted by a mat extending transversely on the conveyor belt and to which is transmitted an alternating movement during shaping by the driver.

25. The shaping device according to claim 24, wherein the mat describes a closed loop by partially winding around return rollers, of which at least one is motor-driven.

26. The shaping device according to claim 24, wherein a box with perforated upper and/or lower walls is inserted between return rollers of the mat to distribute air, in particular heated air, under this latter.

27. The shaping device according to claim 16, wherein it comprises a guide in the form of drums or rollers for providing transverse guiding of the shaping plate, perpendicularly above the conveyor belt.
